(19) United States
(12) Patent Application Publication
(10) Pub. No.: US 2013/0179475 A1
(43) Pub. Date: Jul. 11, 2013

(54) MANAGING THE ASSOCIATION OF DOCUMENTS AND THEIR COPYRIGHTS FOR GENERATING AND PRINTING COMPILATION OF WORKS

(71) Applicant: Toshiro FUJIMORI, Laguna Beach, CA (US)

(72) Inventor: Toshiro FUJIMORI, Laguna Beach, CA (US)

(73) Assignee: KONICA MINOLTA LABORATORY U.S.A., INC., San Mateo, CA (US)

(21) Appl. No.: 13/344,485

(22) Filed: Jan. 5, 2012

(51) Int. Cl. G06F 17/30

(52) U.S. Cl. 707/802; 707/E17.044

(57) ABSTRACT

A method and program for managing the association of works and their copyrights for producing a compilation of works, including the step of obtaining works to be compiled having copyright metadata associated with each work of the works to be compiled by searching for works to be compiled, retrieving copyright metadata of the works to be compiled, and associating copyright metadata to each work of the works to be compiled, and the step of re-associating copyright metadata of a work with a user's own digital file of the work.

### BACKGROUND OF THE INVENTION

1. Field of the Invention

This invention relates to a method of printing compilation of works, and in particular, it relates to such managing the association of documents and their copyrights for generating a compilation of works in electronic or printed forms.

2. Description of Related Art

The recent development of modern printing technology made it possible to generate customized compilation of works in electronic or printer forms on a print-on-demand (POD) basis, which generally refers to production of commercial-quality printed and finished products such as books and booklets on a relatively small scale, typically by a professional print shop, at the request of customers.

For example, in educational institutions, a teacher or professor often needs to assembled a group of works and compile them into a volume of course materials. Another example may be that in an organization, an instructor or trainer needs to assembled a group of works and compile them into a booklet of training materials. Such works may include previously published papers or articles, images and graphics, etc. which are available in hard copies traditionally but now increasingly in electronic (digital) formats, such as in the portable document (PDF) format. These works may include PDF files in the teacher or instructor's own collection, e.g., stored in his or her own computer storage device such as a hard disc drive, or in a file folder assigned to him or her on a server of the institution or organization. These works may also include PDF files in other third parties' collections, e.g., stored in the third parties' servers and make be accessed via a computer network such as the Internet by using uniform resource locator (URL) links. Once the teacher or instructor selects the PDF files, they can be assembled together to generate a compilation of works either in electronic form or printed copies.

An issue often encountered by assembling and generating a compilation of works is the copyright concern, because most works are protected by copyrights. So it is important to manage the licensing of copyrights for the formats (electronic, hardcopy, etc.).

For example, when a teacher or instructor prepares the printing of a volume or booklet consisting of PDF files from his or her own collection and from third parties' sources, some of the PDF files may already have previously obtained copyright licenses, yet for other PDF files it may be necessary to obtain copyright licenses. It is desirable to provide a method to manage the association of documents and their copyrights for generating and printing a compilation of works in electronic or printed forms.

### SUMMARY

The present invention is directed to a method and related apparatus for managing the association of documents and their copyrights for generating a compilation of works in electronic or printed forms.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for managing the association of works and their copyrights for producing a compilation of works, comprising the step of obtaining works to be compiled having copyright metadata associated with each work of the works to be compiled by searching for works to be compiled, retrieving copyright metadata of the works to be compiled, and associating copyright metadata to each work of the works to be compiled, and the step of re-associating copyright metadata of a work with a user's own digital file of the work.

In another aspect, one exemplary embodiment of the present invention further provides a computer program product that causes a data processing apparatus to perform the above methods. The computer program product includes a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a system environment in which embodiments of the present invention may be implemented.

FIG. 2 illustrates a computer-implemented method for managing the association of documents and their copyrights for generating and printing a compilation of works in electronic or printed forms according to an embodiment of the present invention.

### DETAILED DESCRIPTION OF PREFERRED EMBODIMENTS

Embodiments of the present invention provide a method and related apparatus for managing the association of documents and their copyrights for generating a compilation of works in electronic or printed forms.

One example of practical scenarios of such compilation may be that in an educational institution, a teacher or professor desires to assemble and print educational materials for the students. Another example of practical scenarios of such compilation may be that in an organization, an instructor or trainer needs to assemble and print training materials for the members.

When a teacher or instructor needs to assembled a group of works and compile them into a volume or booklet of course or training materials, such works may include previously published papers or articles, images and graphics, etc. that are in, for example, PDF file formats in the teacher or instructor's own collection or a third parties' collections. After the teacher or instructor selects the PDF files, they can be assembled together to generate a compilation of works either in electronic form or printed copies. However, appropriate copyright licenses or clearance may need to be obtained first before the compilation may be produced, printed or distributed.

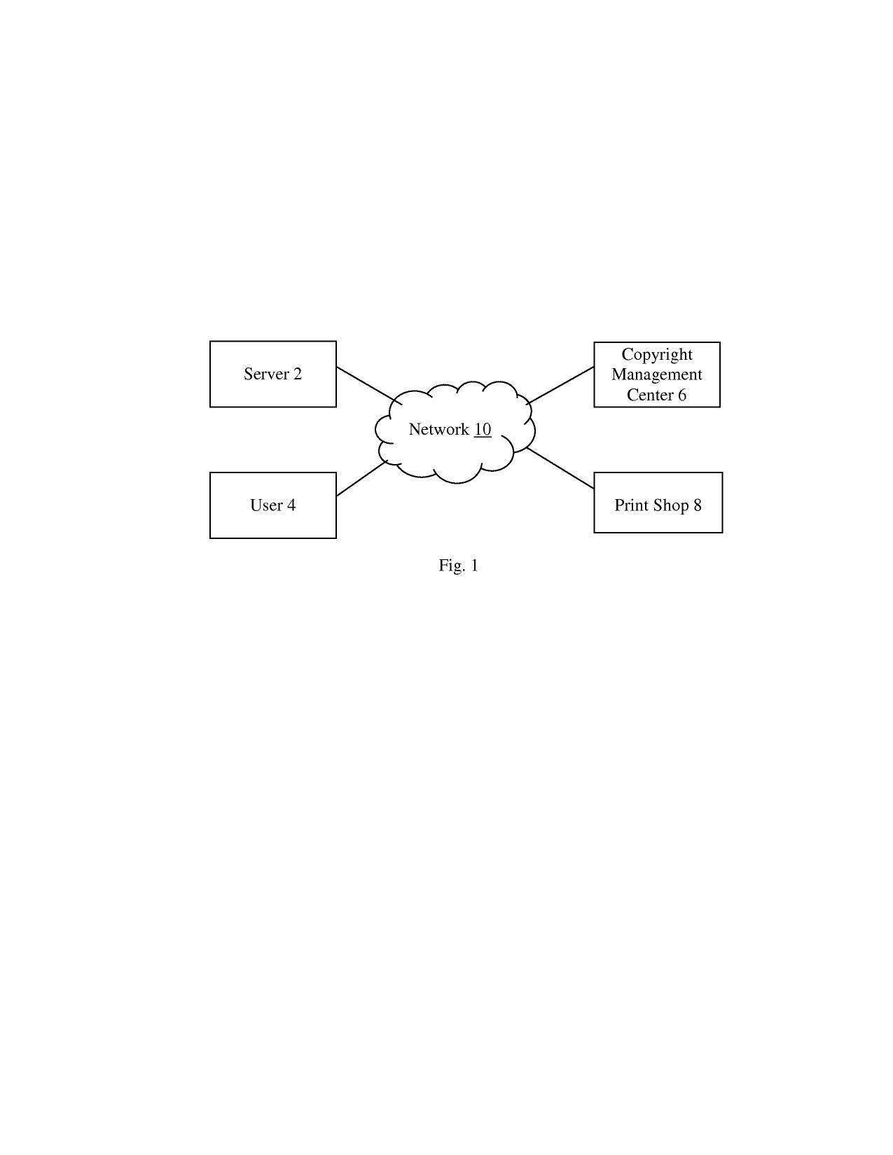

Referring to FIG. 1, there is schematically illustrated an exemplary system environment in which embodiments of the present invention may be implemented. The exemplary system includes a server 2, a client or user computer 4, one or more copyright management center servers 6, and a print shop server 8, connected via one or more computer network 10 such as the Internet or other communication links. A user (such as a teacher or a trainer, or a student or a member of an organization) uses the client computer 4 to interact with the server 2. The server 2 executes a computer program stored in a memory to perform processes according to embodiments of the present invention. The copyright management center servers 6 stores digital contents that may be obtained for use by users, as well as copyright data or license information of such content, for granting or clearing, or facilitates the granting or clearing, of copyright license for such works. The print shop may be a professional print shop equipped with printers and various other image reproduction machines for producing printed products such as books, booklets, etc. The print shop server 8 manages the print jobs submitted to the print shop by the customers.

The server 2 generally provides an integrated service that allows a user to search and acquire copyrighted works from sources of such works, and to compile them into an electronic file, and submit the compiled file to a POD service to produce a printed product. The users may access the server 2 from their own computers 4 via the network 10. The users may establish accounts on the server 2 and store digital contents in his or her account, making it easy to manage digital contents for printing and other purposes. When a user has an account on the server 2, a file folder may be assigned to the user. Sometimes the user may have a digital copy of a work on the user's computer 4 that the user wants to be compiled into the compiled file. In such cases the user may upload the digital copy of the work from the user's computer 4 to the server 2 via the network 10.

The server 2 will allow a user to search for works in the copyright management center servers 6. The search may be by author, title, keywords, etc. The server 2 typically receives a search query from the user 4, and performs the searches in one or more copyright management center servers 6 on behalf of the user. This functionality also allows the user to acquire (e.g. through a purchase) desired works from the copyright management center 6 with a specific permission to use the copyrighted works. The server 2 also allows users to upload documents that the users already possess to be included in the compilation. The server 2 may further interact with the print shop server 8 to submit a compiled file for printing.

In this application, the term “copyright management center” generally refers to a place or service that facilitates the management and distribution of copyrighted materials and the obtaining and transferring of payment to copyright holders. Typically, a copyright management center facilitates legitimate access to copyrighted content by providing a copyright registry, where users can locate copyright information about a work, by also providing a copyright marketplace exchange, where users can buy and sell copyrights, and by further providing a copyright clearance service that can connect with third party distribution platforms. Examples of such copyright management centers may include digital repository of published work maintained by some publishers or digital libraries maintained by various organizations. Another example of copyright management center is the Copyright Clearance Center. Therefore, “copyright management center 6” of the system shown in FIG. 1 may generally include any types of sources of digital contents and their copyright data and license information.

The physical locations or the commercial relationship among the various components of the system of FIG. 1 are not important. For example, the server 2 may be operated by the copyright management center, or the print shop, or a separate institution, organization or commercial establishment.

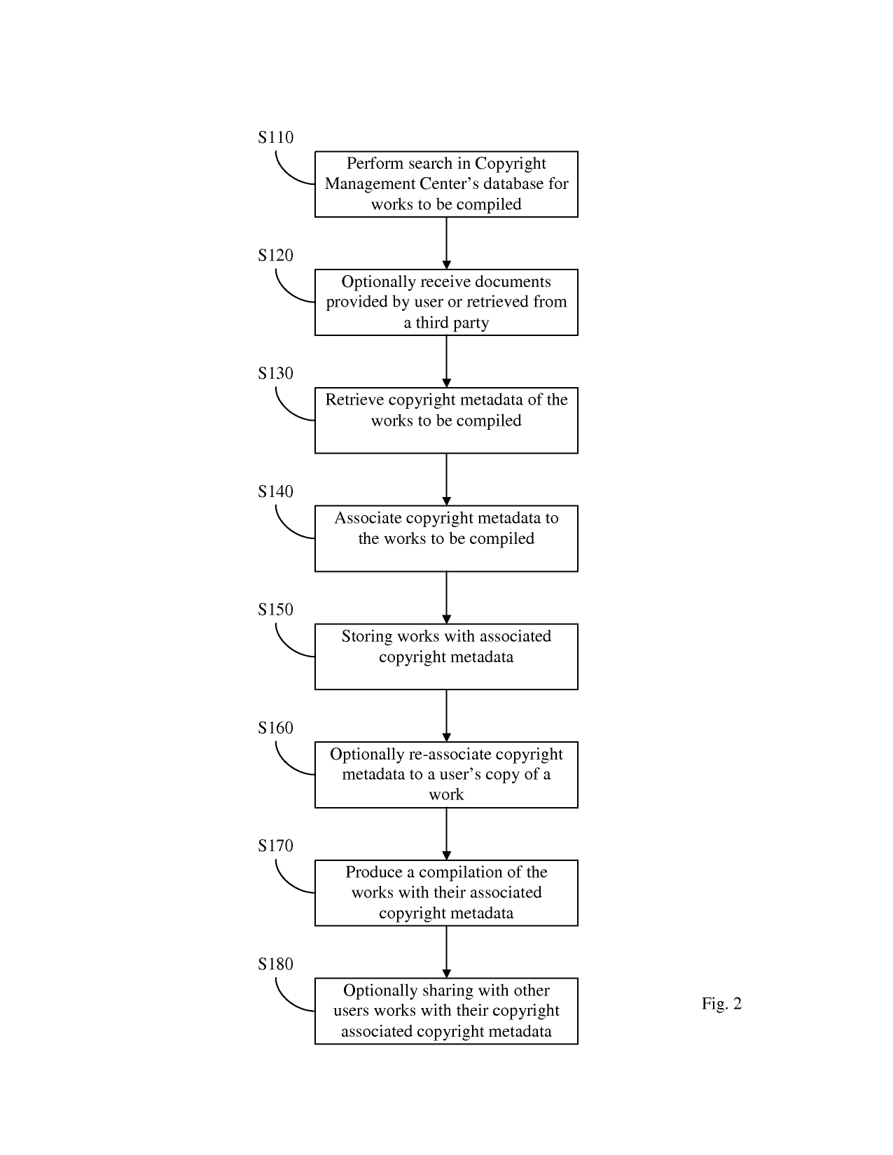

Referring to FIG. 2, there is illustrated the general steps of a method implemented in the server 2 in accordance with the embodiments of the prevent invention. A graphic user interface (GUI) is preferably provided by server 2 to allow the user 4 to interact with the server program to perform various steps of the process described below.

In Step 110, a search is performed in one or more copyright management centers' databases for works to be compiled. This search may be performed by a user who may be, for example, a teacher who needs to compile a volume of course reading materials for his or her students, or an instructor who needs to compile a booklet of training materials for members of his or her organization. In this step generally the server 2 will receive a search query from the user 4 and performs a search in the copyright management center 6.

The database of copyright management center 6 may have the works that are searched for by the user. Optionally in Step 120 the works may be provided by user or retrieved from one or more third parties' sources. The user may upload to the server 2 digital copies of the works in PDF or other suitable file formats from the user's own storage devices such as a hard disc drive on the user's computer 4 via the network 10. The user may also provide Uniform Resource Locator (URL) links to the server 2 for retrieval of works from third parties' sources. The server 2 may also discover URL links of works to be compiled during the search and automatically retrieve them from third parties' sources.

In Step 130, copyright metadata or information of each of the works to be compiled are retrieved from the copyright management center's server. Such copyright metadata (or information) may include, for example, an identification (ID) number of the work that is assigned to the work and used by the copyright management center, the copyright holder's information, copyright license information of the work, etc., that are useful for acquiring the necessary permission or license for the legitimate use of the work.

In Step 140, the copyright metadata of each of the works retrieved is associated with that particular work. This step may be performed by the server 2. Preferably the works are in PDF or other suitable digital file formats. The PDF documents may be provided by the copyright management center as a result of the search step, or uploaded by the user from his or her own collection, or retrieved from a third party's source. These documents form a collection of works desired to be compiled to suit the user's need. As a result of this association step, each of the digital documents in this collection has its copyright metadata respectively associated with that digital document. In addition, the copyright management center 6 may facilitate the acquiring of copyrights permission or license of the works to be compiled when the copyright metadata is associated with each work to be compiled.

In Step 150, the digital documents in the collection with their respective associated copyright metadata are stored, preferably on the server 2. If the user has an account on the server and a folder is assigned to the user, the user may see a listing of these works when the user access his or her file folder which functions as the user's digital content library on the server. While it is preferable that this user's digital content library may be established and maintained, for example, in the form of a file folder assigned to the user at a storage device of the server 2 or the server of the copyright management center 6, it is also possible that it is established or maintained on a storage device of the user's own computer 4. Preferably digital copies of the works with associated copyright metadata are stored in PDF or other suitable file formats on the servers 2 or 6 and accessible through the user's library.

Sometimes the user may realize that he or she has a better digital copy of a document. For example, a retrieved PDF copy of a document may be an outdated version, and the user has in his or her own collection an updated version of the same document in PDF format. This updated” or “newer” or “better” version may be a modified version from an original version of the document which is modified by the user, or it is a better scanned/copied version that has a better resolution or less “dirty” markings from a scanner/copier, or one without a missing page. A user may review and compare the version of a digital file of a work that the user retrieved from the copyright management center and compare it with a version of the digital file of the same work that the user already has, and realizes that he or she has a “better” version of the work. The user's version may be stored on the user's own computer 4 or in the file folder assigned to the user at the servers 2 or 6. If this newer version is not in the user's assigned folder on the servers 2 or 6, then the user may upload it from his or her computer 4 or retrieve it from a third party's source. The user may prefer to use this updated version of the document instead of the outdated version in the compilation. In Step 160 the user may optionally not use the outdated copy in the compilation, but instead use the updated copy of the PDF document in the compilation. If the user chooses to do so, the server 2 will re-associate the copyright metadata of the same work with the user's updated version of the work. With this option, the user can acquire the necessary copyright to use a work but may use his or her own version of the work if the user prefers. When the compilation is printed or otherwise electronically distributed, the user's own version of that work will be used in the compilation but its copyright may still be acquired or otherwise obtained according to the copyright metadata linked to the work.

In Step 170, once the user is satisfied with the digital copies of the works to be compiled, a compilation of the works with their associated copyright metadata can be produced. This step may include the generation of digital file of the compilation for use in a POD process or digital distribution. For example, after the compiled digital file is generated, the server 2 may submit the compiled file to the print shop server 8 for printing at the user's request, or the user may choose to distribute the electronic file without printing. Since each work in the compilation has its copyright metadata directly associated, all necessary copyright permission or license may be easily confirmed or verified when the compilation is printed in hardcopy or distributed in digital form.

In addition, since copyrights permission or license of the works that are accessible through the user's folder assigned on the servers 2 or 6 have been acquired with copyright metadata associated with each work, in Step 180 the user may optionally sharing with other people works in the user's file folder with their copyright associated copyright metadata, including digital copies of the user's own versions (e.g., more updated version) of works which already have their associated copyright metadata.

The above described process may be implemented by a computer software program. The present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

The above described exemplary embodiments of the present invention provide increased options to users who can easily search, access and associate copyright data/information with their desired contents. The users of copyrighted materials can legitimately use such materials according to their own individualized selection of the contents to be compiled into a volume or booklet for POD printing or digital distribution while reducing the cost of obtaining copyright licenses because they will not need to pay for works that they have already obtained licenses before, because of the direct association of copyright metadata with the works selected by the user for compilation in accordance with the present invention.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

1. A method for managing the association of works and their copyrights for producing a compilation of works, comprising the steps of:
retrieving copyright metadata for a work to be compiled in the compilation;
associating copyright metadata of the work with that particular work, such that each work for the compilation has its copyright metadata associated; and
if an original version of a work is to be substituted by a user's own version of the same work for the compilation, re-associating the retrieved original copyright metadata of the work with the user's own version of the work.

2. The method of claim 1, further comprising the step of obtaining a digital file of a work to be compiled from a copyright management center.

3. The method of claim 1, further comprising the step of allowing a user to provide a digital file of a work to be compiled.

4. The method of claim 1, further comprising step of retrieving a digital file of a work to be compiled from a third party.

5. The method of claim 1, further comprising the step of storing the works to be compiled with their associated copyright metadata.

6. The method of claim 1, further comprising the step of producing a compilation of the works with their associated copyright metadata.

7. The method of claim 1, further comprising the step of generating a digital file of the compilation of the works.

8. The method of claim 1, further comprising the step of printing one or more hard copies of the compilation of the works.

9. The method of claim 1, further comprising the step of distributing one or more electronic copies of the compilation of the works.

10. The method of claim 1, further comprising the step of sharing with other users one or more works with their associated copyright metadata.

11. A computer program product comprising a non-transitory computer usable medium having a computer readable code embodied therein for controlling a data processing apparatus, the computer readable program code configured to cause the data processing apparatus to execute a process for managing the association of works and their copyrights for producing a compilation of works, the process comprising the steps of:
retrieving copyright metadata for a work to be compiled in the compilation;
associating copyright metadata of the work with that particular work, such that each work for the compilation has its copyright metadata associated; and
if an original version of a work is to be substituted by a user's own version of the same work for the compilation, re-associating the retrieved original copyright metadata of the work with the user's own version of the work.

12. The computer program product of claim 11, wherein the process further comprises the step of obtaining a digital file of a work to be compiled from a copyright management center.

13. The computer program product of claim 11, wherein the process further comprises the step of allowing a user to provide a digital file of a work to be compiled.

14. The computer program product of claim 11, wherein the process further comprises step of retrieving a digital file of a work to be compiled from a third party.

15. The computer program product of claim 11, wherein the process further comprises the step of storing the works to be compiled with their associated copyright metadata.

16. The computer program product of claim 11, wherein the process further comprises the step of producing a compilation of the works with their associated copyright metadata.

17. The computer program product of claim 11, wherein the process further comprises the step of generating a digital file of the compilation of the works.

18. The computer program product of claim 11, wherein the process further comprises the step of printing one or more hard copies of the compilation of the works.

19. The computer program product of claim 11, wherein the process further comprises the step of distributing one or more electronic copies of the compilation of the works.

20. The computer program product of claim 11, wherein the process further comprises the step of sharing with other users one or more works with their associated copyright metadata.
